(19) United States
(12) Patent Application Publication
(10) Pub. No.: US 2006/0161410 A1
(43) Pub. Date: Jul. 20, 2006

(54) THREE-DIMENSIONAL CAD SYSTEM

(75) Inventors: Masahide Hamatani, Yokohama-shi (JP); Akito Yokoo, Tokyo (JP); Hidekage Sato, Yokohama-shi (JP); Nobuaki Eguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/275,153

(22) Filed: Dec. 15, 2005

(30) Foreign Application Priority Data
Dec. 16, 2004 (JP) 2004-364876(PAT.)
Dec. 12, 2005 (JP) 2005-358080(PAT.)

(51) Int. Cl. G06F 17/50

(52) U.S. Cl. 703/13

(57) ABSTRACT

A CAD system having a plurality of clients connected by a network enables simulations to be run that reflect design information from other client CADs. A server 100 causes a computing unit 101 to reflect in a three-dimensional model generated based on design according to any given client 110-140 design data according to any other client 110-140. Then, using that three-dimensional model, the server carries out an operating simulation and transmits the simulation results to the requesting client. The client that receives the simulation results from the server 100 then displays those simulation results on a design screen.

### FIELD OF THE INVENTION

The present invention relates to a three-dimensional CAD (Computer-Aided Design) composed of a server and a plurality of clients connected to that server by a network. In addition, the present invention relates to a server system in a 3D CAD system and a client CAD system in a 3D CAD system.

### BACKGROUND OF THE INVENTION

Conventionally, in the field of mechanical design a three-dimensional CAD system is used, providing the ability to design mechanisms and mechanical components of mechanisms while displaying them in three dimensions.

In order to support the development of a control program to control a dynamic component such as an actuator or a motor, for example, or a sensor or the like, a system of this type has the capability not to actually assemble a mechanism but to simulate the operation of each constituent component. A 3D CAD system capable of this type of simulation is disclosed, for example, in Japanese Patent Application Laid-Open No. 2001-222572.

However, with the control program operating simulation capability possessed by the conventional 3D CAD system, the command signals for the actuators that drive each of the mechanical components or the mechanical units are linked directly to the operation of that actuator. In other words, the conventional capability does not take into consideration the timing, tolerance, interference, control and the like of the actuator with the operation of other mechanical components or of other actuators. As a result, such simulation cannot reflect the operational tolerances and erroneous operations of the mechanical components that occur due to shifts in control timing and the like attendant upon electronic circuit noise, signal distortion and so forth arising when operating in a state in which the mechanical units have actually been assembled. Consequently, although it is possible to design and to simulate the operation of each and every mechanical unit, it is difficult to perform a simulation that takes into consideration operation in an environment that approaches the state in which a device is actually assembled.

In addition, ordinarily, devices are created not just out of mechanisms but a combination of mechanical units, electronic circuits and control software (firmware), and in some cases involve optical design as well. Conventionally, electronic circuit and firmware development and optical design have been implemented by individual development systems that are separate from the 3D CAD systems used for mechanical design. Moreover, ordinarily, these individual development systems are not compatible.

In other words, as described above, even though 3D CAD systems for mechanical design have the capability to simulate according to the control program, the control program used therein is a specialized one used solely for such 3D CAD systems, and is not the control program that is actually under development.

Therefore, mechanical design proceeds leaving open the possibility that the mechanism will not perform as desired when the control program that is ultimately developed is used. Alternatively, in order to eliminate this possibility, it is possible to import the finalized control program into the 3D CAD system and repeat operating simulations each time the control program is changed. However, because CAD systems are incompatible, importation is not easy but takes time and effort. In addition, complete importation is sometimes unattainable due to limitations on simulation capability.

Similarly, despite the necessity of ultimately operating in tandem together with other design systems, because linkage between individual design systems at the design stage is not possible it takes time and effort to make adjustments until the design is finalized. Accordingly, when carrying out design in an environment in which a plurality of different development systems coexists, it is extremely difficult to share data between development environments during design. A remedy for this situation is strongly desired.

### SUMMARY OF THE INVENTION

The present invention is conceived as a solution to at least one of the problems of the conventional art described above. Specifically, the present invention has as its object to provide a 3D CAD system that allows design while performing operating simulations using data designed on another CAD system.

According to an aspect of the present invention, there is provided a three-dimensional CAD system comprising: a server; and a plurality of clients, the server and the plurality of clients connected by a network, the server comprising a data storage unit that stores data and a computing unit that reads and writes data to and from the data storage unit in response to requests from the clients and generates a three-dimensional model and an operating simulation of such three-dimensional model, the server, using the computing unit, generating operating simulation data for the three-dimensional model generated by causing design data according to other clients to be reflected in the three-dimensional model generated based on design data from any given client and transmits such generated operating simulation data to the given client over the network, the given client making an operating simulation linked to design data according to the other clients displayable by receiving the operating simulation data transmitted from the server and displaying a screen on which design is carried out.

According to another aspect of the present invention, there is provided a server system in a three-dimensional CAD system comprising: a server; and, a plurality of clients, the server and the plurality of clients connected by a network, the server comprising a data storage unit that stores data and a computing unit that reads and writes data to and from the data storage unit in response to requests from the clients and generates a three-dimensional model and an operating simulation of such three-dimensional model, the server making it possible to display on a given client side an operating simulation linked to design data according to other clients by using the computing unit to generate operating simulation data for a three-dimensional model generated by causing design data according to the other clients to be reflected in a three-dimensional model generated based on design data from the given client, and transmits such generated operating simulation data to the given client over the network.

According to a further aspect of the invention, a client CAD system in a three-dimensional CAD system comprising: a server; and a plurality of clients, the server and the plurality of clients connected by a network, the server comprising a data storage unit that stores data and a computing unit that reads and writes data to and from the data storage unit in response to requests from the clients and generates a three-dimensional model and an operating simulation of such three-dimensional model, the server, using the computing unit, generating operating simulation data for a three-dimensional model generated by causing design data according to other clients to be reflected in a three-dimensional model generated based on design data from any given client and transmits such generated operating simulation data to the given client over the network, the given client making an operating simulation linked to design data according to the other clients displayable by receiving and displaying on a screen on which design is carried out the operating simulation data transmitted from the server.

According to the present invention, in a 3D CAD system composed of a server and a plurality of clients, data designed by the clients can be shared, thus allowing simulations that combine elements that have been designed separately, for example, mechanical, electronic circuit, software, optical components and the like, and therefore making possible simulations as completed products even without complete assembly of the test product, thereby greatly improving the development and design environment, permitting the number of design trials and units to be reduced, and greatly reducing development and design costs. In addition, the present invention provides the ability to simulate design targets at the design stage, permitting visual confirmation of the movements of such design targets, and thus facilitates parallel design and joint testing with other designers as well as reduction in specification errors.

Other objects and advantages besides those discussed above shall be apparent to those skilled in the art from the description of preferred embodiments of the invention which follows. In the description, reference is made to the accompanying drawings, which form a part thereof, and which illustrate an example of the various embodiments of the invention. Such examples, however., are not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the basic configuration of a 3D CAD system according to an embodiment of the present invention;

FIG. 2 is a block diagram showing the hardware configuration for the clients according to a 3D CAD system;

FIG. 3 is a block diagram showing the configuration of a server;

FIG. 4 is a diagram showing the flow of commands and data between a client mechanical CAD and the server;

FIG. 5 is a diagram showing an image of a parts selection screen of the mechanical CAD;

FIG. 6 is a diagram showing a specific example of the parts selection screen shown in FIG. 5;

FIG. 7 is a diagram showing an image of an electronic circuit as seen from the mechanical CAD screen;

FIG. 8 is a diagram showing an image of firmware as seen from the electronic circuit CAD; and

FIG. 9 is a schematic diagram showing the results of a simulation of the characteristics of a mechanism on the mechanical CAD screen.

### DETAILED DESCRIPTION OF THE INVENTION

Preferred embodiments of the present invention will now be described in detail in accordance with the accompanying drawings.

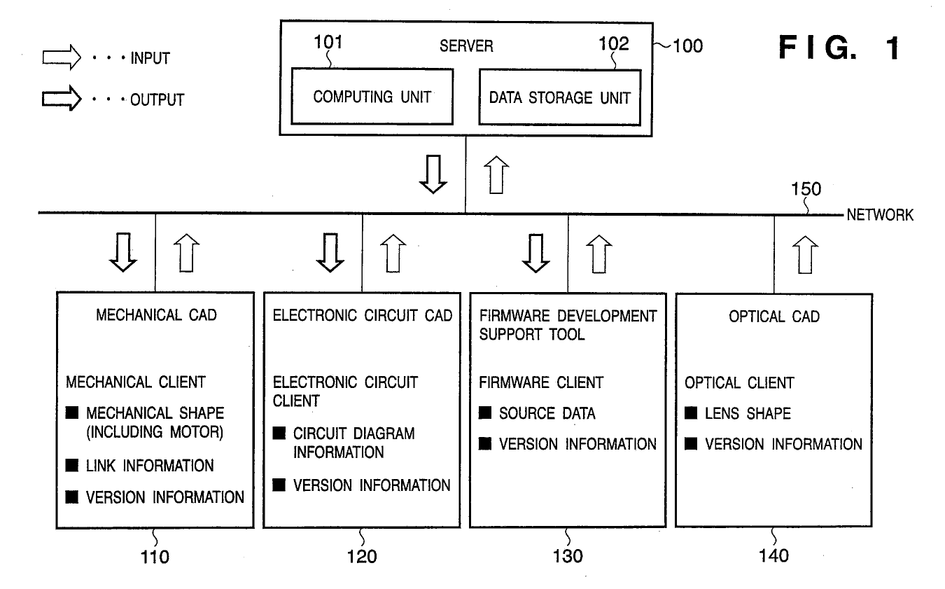

FIG. 1 is a diagram showing the basic configuration of a 3D CAD system according to an embodiment of the present invention. In the diagram, reference numeral 100 designates a server that comprises the vital center of the system, 110 designates a mechanical CAD as a client that carries out design of mechanical units that comprise a device, and 120 designates an electronic circuit CAD as a client for carrying out design of electronic circuit parts of the device. In addition, reference numeral 130 designates a firmware development support tool for development of, and development support for, a program (firmware) that controls the mechanical units and the electronic circuit parts of the device, and 140 designates an optical CAD that designs a lens unit and other optical components.

The server 100, and the clients composed of the mechanical CAD 110, the electronic circuit CAD 120, the firmware development support tool 130 and the optical CAD 140, are connected by a network 150. Data of all types is transmitted and received between the clients 110-140 and the server 100, and among the plurality of clients 110-140 through the server 100.

A computing unit 101 and a data storage unit 102 are provided in the server 100. In accordance with requests from the clients 110-140, the computing unit 101 extracts the necessary data from the data storage unit 102, stores the data, and executes a computation process. Then, the computing unit 101 generates a three-dimensional model of the device that is the design target, generates data for simulating various operations of the device, and executes processes to store the data in the data storage unit 102 or download the data to the clients 110-146.

A description is now given of the configurations of the clients 110-140. The mechanical CAD 110 comprises a mechanical design environment with data on the shape, operation and so forth of the mechanical components used in design and an application for combining the mechanical components and designing mechanical parts. Similarly, the electronic circuit CAD 120 comprises a circuit design environment with data on the various circuit components, circuit configurations, circuit diagrams and various operating parameters and the like relating to the electronic circuits of the device, and an application for carrying out circuit design based on such data. The optical CAD 140 comprises an optical design environment with data relating to the lens shape, optical characteristics, and the optical-structure as a lens unit, and an application for carrying out optical design of the lens unit and the like based on that data.

In addition, firmware, in other words, a program for controlling the operation of the mechanical parts, the electronic circuits, and the optical components of the device, is stored in the firmware development support tool 130. Then, as is described later, the firmware development support tool 130 is configured to share the latest data or design environments of each of the other clients (the mechanical CAD 110, the electronic circuit CAD 120, and the optical CAD 140) and to be able to carry out operating simulations in real time.

With such a system, in accordance with the designs executed by the clients 110-140, the data necessary for those designs is read out from the data storage unit 102 of the server 100 and supplied to the clients. At the same time, the design operations that are carried out at the clients 110-140 are uploaded to the computing unit 101 of the server 100 in real time, and a three-dimensional model of the device (the mechanical part) is formed in the server 100. The three-dimensional model data is then stored in the data storage unit 102, and moreover, is downloaded to a requesting client in response to a request from the clients 110-140. At the requesting client, the downloaded three-dimensional model cat be displayed so as to reflect that client's own design data as necessary, to carry out simulations using the three-dimensional model, and so forth.

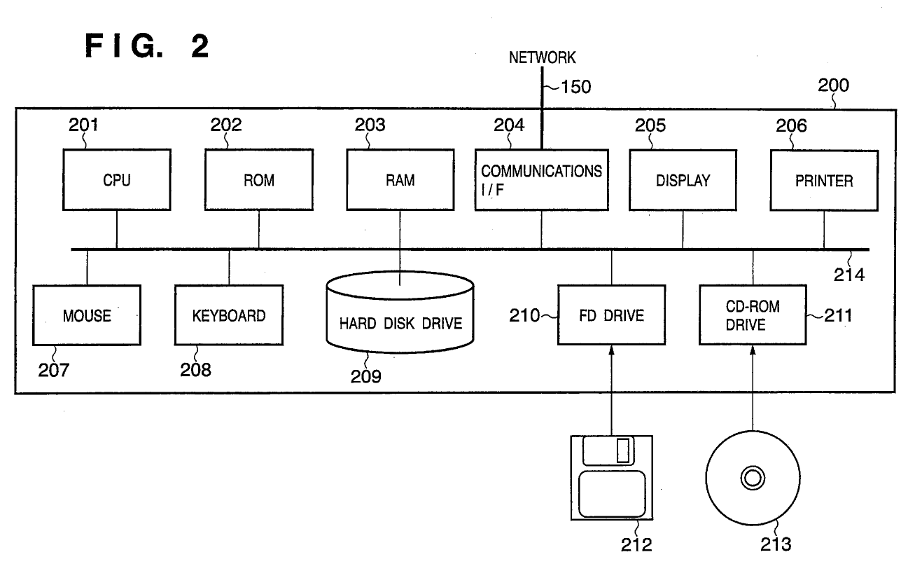

FIG. 2 is a block diagram showing an example of a hardware configuration of the clients 110-140 according to the 3D CAD system of the present embodiment.

Any or all of the clients 110-140 can be comprised of general-purpose computers 200. The computer 200 has a CPU 201 for a controller, a boot program that the CPU 201 executes when the computer is turned on, and a ROM 202 storing various programs that depend on hardware of the computer 200. A RAM 203 stores programs that the CPU 201 executes and data and the like that the CPU 201 uses in its computations. A communications interface (I/F) 204 is an interface for communication with the server through a network 150. The computer 200 is further comprised of a display 205, a printer 206, a mouse 207, a keyboard 208, a hard disk drive 209, a FD drive 210, and a CD-ROM 211.

Application programs and operating systems or the like for causing the clients to Serve as CAD units are stored on the hard disk drive 209.

The CPU 201 operates based on programs stored on the ROM 202 and the hard disk drive 209 (which are rendered to the RAM 203 during execution) and controls all parts of the computer 200. The communications I/F 204 provides communications with other devices (the clients or the server) over the network 150. The hard disk drive 209 stores programs and data for implementing the functions that the computer 200 provides to the user, which it provides to the CPU 201 via the RAM 203. The FD drive 210 and the CD-ROM drive 211 read data from removable media such as a FD 212, a CD-ROM 213 or the like, and provide that data to the RAM 203. An internal bus 204 connects the devices in the computer 200.

It should be noted that, the server can be also implemented by the computer 200 shown in FIG. 2, by changing the programs that are executed by the CPU 201 to those that implement the functions of the server 100.

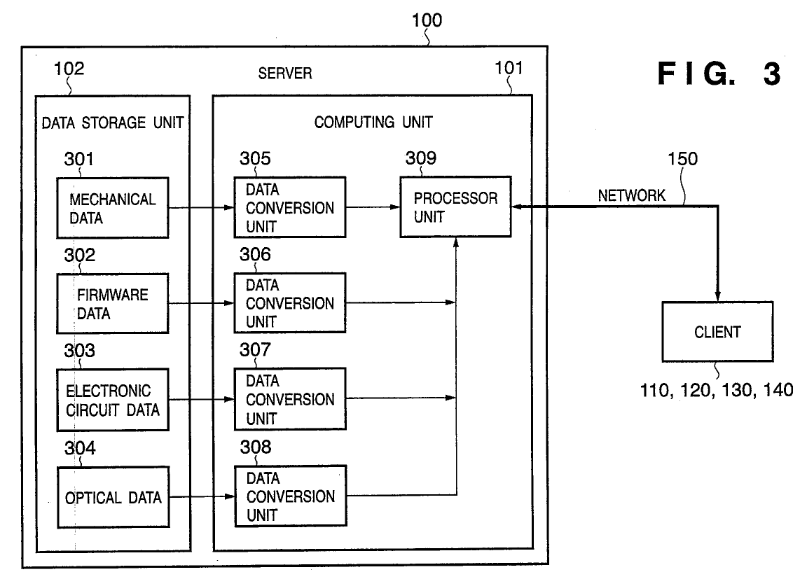

FIG. 3 is a block diagram showing a functional configuration example of the server 100.

The server 100 is comprised of the computing unit 101 and the data storage unit 102. The data storage unit 102 is implemented by, for example, a storage device like the hard disk drive 209. Then, mechanical data 301, electronic circuit data 303, optical data 304 and firmware data 302 corresponding to the mechanical CAD 110, the electronic circuit CAD 120, the optical CAD 40 and the firmware development support tool 130 that are the clients is recorded and stored.

For example, data on the configuration, size, shape and characteristics of a variety of mechanical components necessary for mechanical design, as well as of dynamic components such as the actuator, motor and the like, are stored in the mechanical data 301 corresponding to the mechanical CAD 110. Then, the form and attributes of the registered components and data are managed and the necessary data is sent to the computing unit 101 based on a request from a processor unit 309. The process is the same for the electronic circuit data 303, the optical data 304 and the firmware 302. In other words, data relating to the electronic circuit components and electronic circuit data that is designed with the electronic circuit CAD 120 are contained in the electronic circuit data 303. Data relating to the optical component and optical design data that is designed with the optical CAD 140 are contained in the optical data 304 and firmware data created with the firmware development support tool 130 is contained in the firmware data 302.

Then, for example, the computing unit 101 implemented by the CPU 201, a mechanical data conversion unit 305, a firmware data conversion unit 306, a firmware data conversion unit 307, and an optical data conversion unit 308. In addition, the processor unit 309 performs a computation process on the data that is converted by the data conversion units 305-308 based on a program. The data conversion units 305-308 read out the mechanical data 301, the electronic circuit data 303, the optical data 304 and the firmware data 302 from the data storage unit 102 based on instructions from the clients. Then, for example, with mechanical unit design, according to the design environment of the requesting client the data conversion unit converts mechanical data. Specifically, for registered component data read out from the mechanical data 301, the data conversion unit converts display scale, point of installation in the device, attitude, and so forth into pre-registered characteristics and specifications that are importable by the client. It should be noted that, if the requesting client is the mechanical CAD 110, data conversion by the requesting client is not a prerequisite. As a result, it is possible to use design data interchangeably among different CAD systems. The converted data is then sent to the processor unit 309 and supplied to the requesting client.

Similarly, the electronic circuit data 303 is read out in accordance with instructions from the clients 110-140. Then, the data conversion unit 307 converts the data into an importable format that the requesting client can import, and the data is then supplied to the requesting client via the processor unit 309.

The process is the same for the optical data 304 and the firmware data 302, with the data being supplied to the requesting client via the processor unit 309 after it is converted into a data format in accordance with the request.

In other words, a request signal output by the mechanical CAD 110 client is supplied to the processor unit 309 inside the computing unit 101 of the server 100 through the network 150. The processor unit 309, based on the request signal and the programs stored in the RAM 203 and on the hard disk drive 209, issues a request for the necessary data to the data storage unit 102. The data storage unit 102 reads out the requested data 301, 302, 303, 304, and sends it to the corresponding data conversion units 305, 306, 307, 308, respectively.

Each of the data conversion units 305-308 performs data conversion on the data based on the data conversion programs stored in the RAM 203 and on the hard disk drive 209, and provides the converted data to the processor unit 309. Using the converted data provided by the data conversion units 305-308, the processor unit 309 performs such computations as simulations and the like and provides the results of those computations to the mechanical CAD 110 that is the requesting client via the network 150. The mechanical CAD 110 then displays the computation results on the display 205, stores it as a file on the hard disk drive 209, and so forth. These routines are the same for clients 120, 130 and 140 as well.

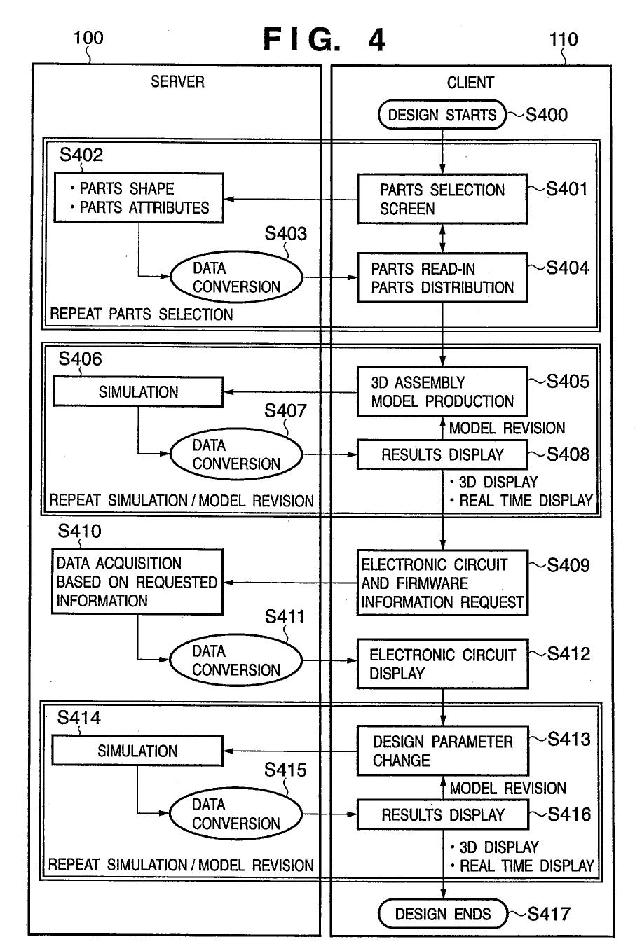

FIG. 4 is a diagram showing the flow of commands and data between a requesting client and the server 100.

FIG. 4 shows an example of a case in which the mechanical CAD 110 is the requesting client, and in FIG. 4 the mechanical CAD 110 is also called the client 110. FIG. 4 shows the exchange of all types of data that is in actuality carried out both ways between the server 100 and the client 110 as well as the content of the processing. In addition, the diagram shows the procedures for all operations and for the transmission and reception of data in a case in which a mechanical designer (that is, the mechanical CAD 110 user) designs the mechanical part using the 3D CAD system according to the present embodiment. Here, the flow of processing runs from top to bottom in FIG. 4, and the processes of the steps can be carried out in parallel.

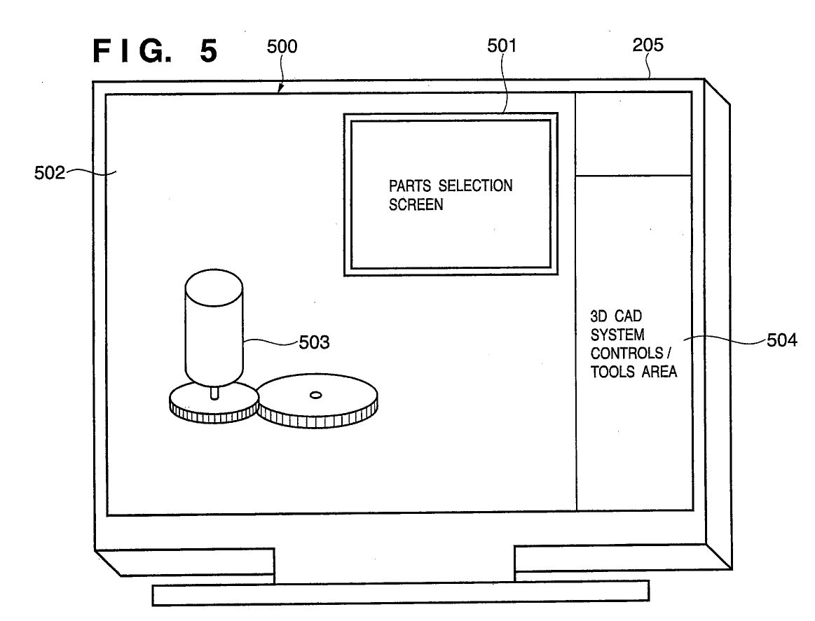

In step S400 the mechanical designer activates for example a design application and commences operations for design. Then, in the mechanical CAD 110, first the user operates the mechanical CAD in order to select the components for the design of the mechanical parts of the device to call up and display a parts selection screen 501 on a screen 500 of the mechanical CAD 110, as shown in FIG. 5. It should be noted that, although not specifically stated below, the operation of the mechanical CAD 110 is carried out by the user manipulating a mouse 207 and a keyboard 208, similar to the manipulation of an ordinary GUI (Graphical User Interface) based application. In addition, the manipulation of the mouse 207 and the keyboard 208 by the user is reported to the design application by the OS which is run on the mechanical CAD 110, in response to which the deign application performs a variety of operations, such as screen display and the like. These sorts of processes are well known in the field of information processing and moreover are unrelated to the essence of the present invention, and therefore a detailed description thereof is omitted.

FIG. 5 is a diagram showing an image of a mechanical CAD 110 parts selection screen. A selection screen 501 for parts registered in the server 100 as mechanical data 301 (including units composed of a plurality of parts combined) is displayed on the mechanical CAD screen. The user can select the parts necessary for design from the parts selection screen 501 and place them in a design operation area 502.

FIG. 5 shows a display screen 500 of the mechanical CAD 110 in a state in which mechanical unit 503 registered as parts are selected from the parts selection screen 501 and placed in the design operation area 502. The display screen 500 is comprised of the design operation area 502 capable of displaying design-stage mechanical unit 503 in three dimensions and a 3D CAD system controls/tools area 504 for carrying out design of the mechanical unit 503 using a variety of commands and tools. In addition, the parts used in design that are called up from the server 100 and selected are displayed in window form by the parts selection screen 501. The parts selection screen 501 can be displayed and erased by an instruction from the 3D CAD system controls/tools area 504.

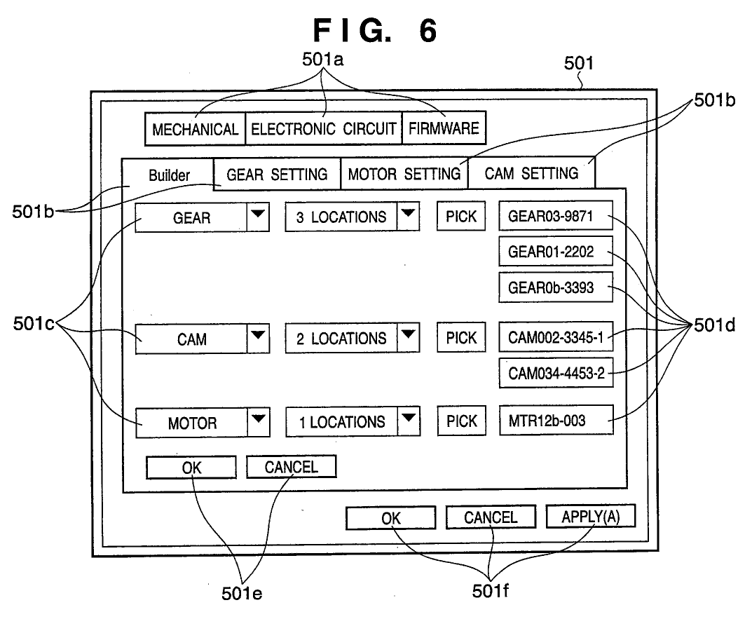

FIG. 6 is a diagram showing a specific example of the parts selection screen 501 shown in FIG. 5. Buttons 501a for switching between mechanical, electronic circuit and firmware is provided on the parts selection screen 501, and FIG. 6 shows a state in which the mechanical button 501a is selected. The parts selection screen 501 is further provided with tabs 501b, and selecting one of the tabs 501b enables switching between pages for performing detailed settings for an overall configuration setting (builder), a gear setting, a motor setting and a cam setting. The builder calls up the necessary registered components. In addition, switching to other pages enables setting and changing various attributes of the gear, motor, cam and so forth.

In other words, the user, by first selecting a button 501a that selects the mechanical, electronic circuit or other such design target in the parts selection screen 501, selects a mechanical, electronic circuit or other such design target. As described above, in the case shown in FIG. 6, the mechanical button for designing a mechanism is selected. Then, furthermore, the overall configuration setting (builder) page is selected from among individual pages provided for the overall configuration setting (builder), gear setting, motor setting and cam setting and displayed.

On the builder page, a list of components that form the mechanical unit 503 that is the part displayed in the current design operation area 502 is displayed by component type (that is, gear, cam, motor or the like), quantity, and model number or component number. In other words, in the example shown in FIG. 6, the mechanical unit 503 is comprised of three gears, two cams and one motor, displayed together with model number and component number 501d.

Both type and quantity are displayed as pull down menus 501c, enabling other types of components to be selected and the quantities to be changed. The model types or component numbers Sold are displayed in such as way as to be selectable and changeable. In addition, if the “pick” button is clicked in a state in which the model type 501d is selected, and furthermore, if the tab 501b is selected and the switch is made to a detailed setting page, detailed settings can be carried out for the selected model number component.

When the various settings for the constituent elements have been completed as thus described, a confirmation operation or a cancellation operation can be carried out by clicking the OK or the Cancel button 501e at the bottom of the screen. It should be noted that the components that can be selected with the parts selection screen 501 are components that are registered in the server 100 data storage unit 102, specifically in the mechanical data 301. The user continues to operate from the parts selection screen 501 until all the necessary components have been acquired. It is also possible to generate and use new components by changing the attributes of the components that are not registered using the detailed setting screen.

After these settings has been carried out for each of the plurality of pages of the builder, gear setting, motor setting and cam setting shown by pages 501b, the settings can be confirmed or redone by clicking on the OK or the Cancel button 501f. It should be noted that, if the Apply button is clicked, setting changes are reflected only in the design operation area 502 display, thus permitting the user to determine whether or not to carry out the setting change after confirming the results of the setting change on the design operation area 502 display.

Returning to FIG. 4, in step S401, in the client 110 parts selection screen 501, the user specifies the necessary constituent components of the gears, cams, motors and the like necessary for the design using each of the pages for the builder, gear setting, motor setting and cam setting. In addition, the user inputs as necessary the data, quantity and the like for the necessary attributes, specifications, characteristics and the like. Once the user completes input of the necessary data regarding the constituent components and presses the OK button 501f, the setting information established by the parts selection screen 501 is transmitted to the computing unit 101 in the server 100 through the network (step S402). The processor unit 309 analyzes the information from the client 110. If the transmission of new data to the client 110 is necessary, for example an addition or a change of parts, then data on the shape, attributes and so forth of the parts registered in the mechanical data 301 of the data storage unit 102 is read out and downloaded to the client 110 (step S404). In addition, the three-dimensional model of the mechanical unit that the client 110 is currently designing and which is registered in the mechanical data 301 is refreshed, enabling the latest design data always to be held in the client 110. As a result, when the other clients request a simulation of the mechanical unit, it is possible to execute a simulation using the client 110 design data.

At this time, if the format of the data that is read out is a format that cannot be imported directly by the client 110, then in step S403 the data conversion unit 305 converts the data into a pre-registered, importable data format that the client 110 can import, which is then supplied to the processor unit 309. The data that is converted by the data conversion unit 305 is then sent to the processor unit 309 and to the client 110 through the network the client 110 takes the received data and displays it in the design operation area 502, which is capable of displaying the mechanical unit 503 in three dimensions inside the display screen 500 of the display 205 as a three-dimensional graphic. Thus, during or after parts selection, three-dimensional modeling of the components necessary for design is carried out and placed in the design operation area 502 (step S405).

Thus, when information on the selection and the setting and changing of attributes of various constituent components is transmitted to the server 100 side in the process of step S402, a three-dimensional model of the assembled mechanism is generated or refreshed on the server 100 side based on that information. This three-dimensional model is then stored in the data storage unit 102. In addition, the three-dimensional model is also supplied to the client 110. At the client 110, the configuration and the operation of the mechanism can be confirmed using this three-dimensional model. In addition, an operating simulation can be carried out within the range provided by the client 110.

The important point here is that the server 100 saves the clients' current design data in the data storage unit 102, which enables data designed or set by the other clients, such as the electronic circuit CAD 120, the firmware development support tool 130 and the like, to be referenced while carrying out mechanical design with the mechanical CAD 110. In addition, operating simulation that reflects design information of these other clients can be carried out.

In step S405, the client 110 issues a request to the server 100 side to execute a simulation based on the three-dimensional model supplied from the server 100 side. In accordance with that request, the server 100 computing unit 101 reads out the necessary data from the data storage unit 102 and carries out a simulation of the operation of the three-dimensional model (step S406). Then, the simulation results are converted into importable data that the client 110 can import by the data conversion unit 305 (step S407) and supplied to the client 110, enabling operating simulation results that are based on a three-dimensional model that reflects the operations of all clients, including the client 110, to be acquired at the client 110 at any given time, either during or after parts selection. The operating simulation result data is then provided to the user in a predetermined format (for example, in the form of a graph or the like) by the client 110.

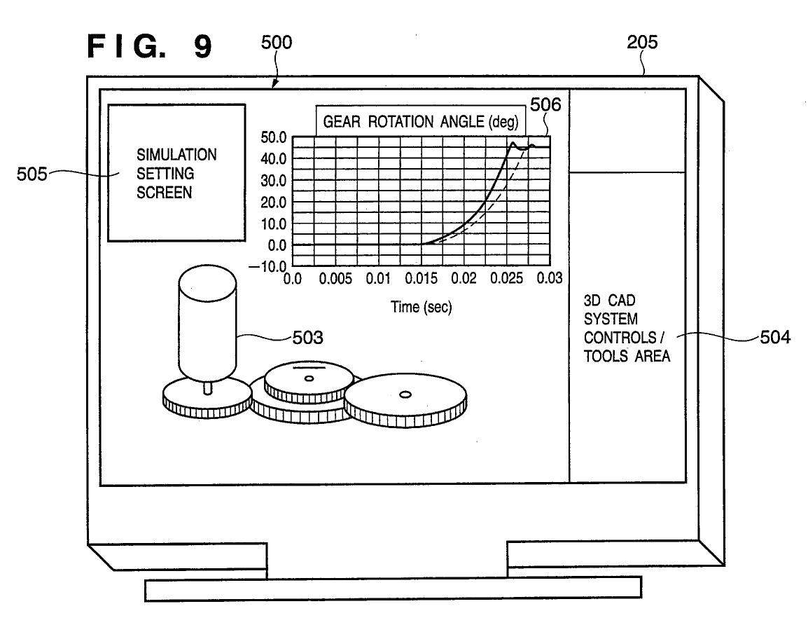

Based on the simulation results, the user revises the mechanism, the mechanical components, the control operations and so forth (step S408, step S405) and again transmits those revisions to the server 100 side, by which a three-dimensional model that reflects these revisions is generated by the procedure described above. Then, the user requests an operating simulation that uses the three-dimensional model that reflects these revisions and makes further revisions as necessary while examining the results of that simulation. Here, FIG. 9 is a schematic diagram of the display of simulation results of the characteristics of the mechanism on the mechanical CAD 110 display.

The user, as shown in FIG. 9, sets simulation conditions for the actuator and the sensor included in the mechanical unit under design using the simulation setting screen 505 displayed on the screen of the display 205 of the mechanical CAD 110. The user then inputs commands from a menu bar, for example, not shown, thus ordering the start of simulation. The processor unit 309 inside the computing unit 101 of the server 100 then performs a simulation of the operation of the mechanical unit based on the actuator characteristics and the limiting conditions that are provided by the simulation conditions and the parts attribute information set by the user. The data conversion unit 305 then converts these simulation (computation) results into a displayable format that can be displayed by the client 110 and transmits the results to the client 110. Based on the data thus received, the client 110 then displays the simulation results on the display (step S409). The user then changes the conditions of the simulation as well as the parts attributes and limiting conditions so as to satisfy predetermined performance requirements and repeats the simulation.

In the present embodiment, the client 110 user can at least reference the information of other clients used to drive the mechanical unit either during or after simulation of the mechanical unit under design. As information of the other clients, there is, for example, electronic circuit, firmware and application information. What kind of information to reference is determined, for example, by a call-up screen. For example, a description is given of a case in which, when carrying out mechanical design using the mechanical CAD 110, information on the electronic circuit used to drive that mechanical unit is read out and displayed on the screen of the mechanical CAD 110. The client 110 user specifies the information to be referenced using the call-up screen and transmits a request for information to the server 100 (step S409). In response to that request, the server 100 processor unit 309 reads out the requested electronic circuit data from the electronic data 303 of the data storage unit 102. The data conversion unit 307 then converts that data into a displayable format that can be displayed by the client 110 (step S411). The converted data is then transmitted to the mechanical CAD 110 through the processor unit 309 and displayed in the screen 500 (step S412).

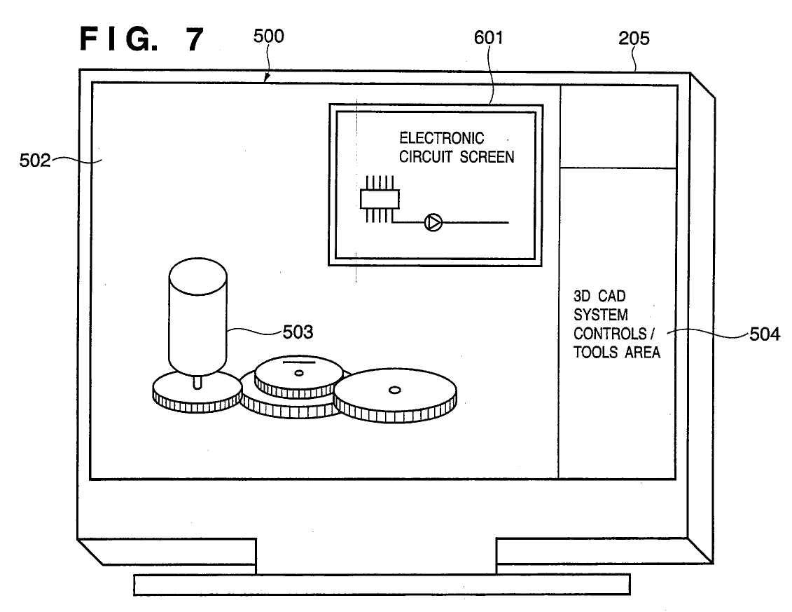

Such a state is shown in FIG. 7. FIG. 7 is a diagram showing an image of an instance in which an electronic circuit designed by the electronic circuit CAD 120 is displayed in a window. In FIG. 7, the electronic circuit is displayed as a sub-window 601 in the screen 500 if the mechanical CAD 110.

Similarly, in the case of the reading out of firmware information and displaying it on the mechanical CAD 110 screen, a request for firmware is issued to the server 100, by which the processor unit 309 reads out the requested data from the firmware data 302 of the data storage unit 102. The data conversion unit 306 then converts the data into a displayable format that can be displayed by the mechanical CAD 110 and transmits the converted data to the mechanical CAD 110. The mechanical CAD 110 displays the data thus received on the screen as with the electronic circuit data.

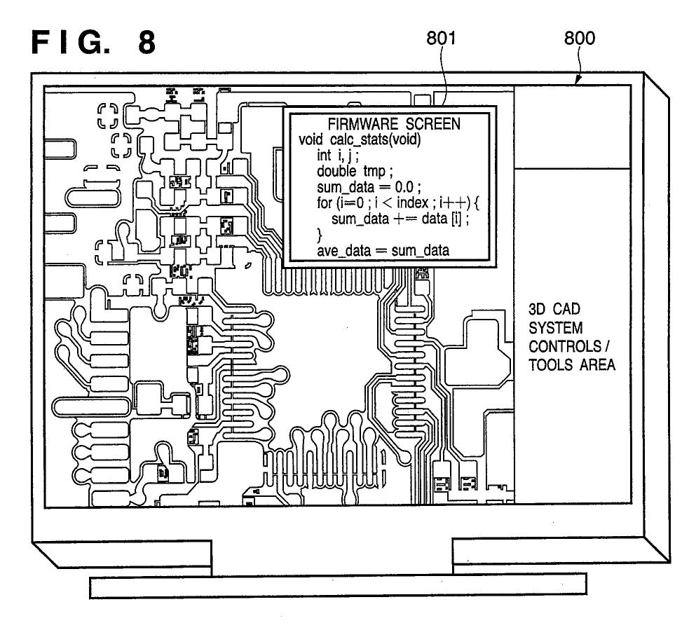

FIG. 8 shows a state in which, using the same procedure, a request for firmware data is issued from the electronic circuit CAD 120 to the server 100 and a source list of a program under development by the firmware development support tool 130 is displayed as a sub-window 801 in the electronic circuit CAD 120 screen 800.

The user can study the design information (electronic circuit 601 and the like) of the other clients displayed in the manner described above and can change the necessary design parameters. For example, controlling the electronic circuit CAD 120 remotely from the mechanical CAD 110 using a hypothetical desktop technology know as VNC (Virtual Network Computing) allows the electronic circuit 601 to be changed from the mechanical CAD 110, enabling the mechanical CAD 110, for example, to make changes not only to the design of the mechanical unit but also to the electronic circuit that drives the mechanical unit and to run simulations so that the designed mechanical unit operates properly.

As described above, the server 100 of the present embodiment retains the current design data resident in the clients 110-140 and carries out simulations using a three-dimensional model that reflects that data. Therefore, when there is a simulation request from the mechanical CAD 110, the processor unit 309 runs a simulation of the driving of the mechanical unit including such physical phenomena as the noise and the signal characteristics degradation of the electronic circuit designed by the electronic circuit CAD 120.

The simulation results can be freely processed and used by the requesting client. For example, FIG. 9 shows a situation in which the server 100 is requested to run a simulation of the designed mechanical unit drive characteristics, that is, the mechanical unit 503, for a final gear rotation angle over time when a predetermined voltage is applied to the motor and the motor is driven, with the screen 500 of the mechanical CAD 110 displaying the simulation results from the server 100 as a timing chart (characteristics chart) 506. In the timing chart characteristics chart 506, the logical fluctuation in the angle of rotation is shown as a dotted line. However, it can be seen from the simulation results, which are indicated by the solid line, that the waveform is distorted by the characteristics of the electronic circuits that drive the motor.

The user, while monitoring the simulation results, changes the design parameters of the electronic circuits as necessary and/or revises the settings of the parts (step S413), and transmits the revised data to the server 100 (step S414). The server 100 takes that revised data and causes the processor unit 309 to revise the three-dimensional model, and then carries out simulations that reflect those revisions in response to requests from the clients 110-140. As in step S407, the data conversion units 306, 307 convert the simulation results into importable data formats that can be imported by the requesting clients (step S415). Then, the requesting clients display the data thus received (step S416).

The client can further change and revise the three-dimensional model while monitoring the simulation (step S416→step S413).

Thus, as described above, while carrying out mechanical design at the mechanical CAD 110, information on the electronic circuit therefor (see FIG. 7) as well as characteristics that show the actual drive characteristics (FIG. 9) can be displayed, and as a result enabling the user to carry out simulations while referring to different categories of information (mechanical, electronic circuit, firmware and so forth) in real time. Then, when all designs are completed, design terminates (step S417).

Thus, as described above, the present invention achieves a design environment that integrates mechanical, electronic circuit, software and optical design information and enables compatible simulations, and therefore allows the user to run simulations of a completed product without having to fully assemble a test product. Furthermore, the present invention permits visual confirmation of the movements of the design target, thus greatly improving the development and design environment, permitting the number of design trials and units to be reduced and greatly reducing development and design costs.

As many apparently widely different embodiments of the present invention can be made without departing from the spirit and scope thereof, it is to be understood that the invention is not limited to the specific embodiments thereof except as defined in the appended claims.

This application claims priority from Japanese-Patent Application Nos. 2004-364876 filed on Dec. 16, 2004 and 2005-358080 filed on Dec. 12, 2005, which are hereby incorporated by reference herein.

What is claimed is:

1. A three-dimensional CAD system comprising:
a server; and
a plurality of clients,
the server and the plurality of clients connected by a network,
the server comprising a data storage unit that stores data and a computing unit that reads and writes data to and from the data storage unit in response to requests from the clients and generates a three-dimensional model and an operating simulation of such three-dimensional model,
the server, using the computing unit, generating operating simulation data for the three-dimensional model generated by causing design data according to other clients to be reflected in the three-dimensional model generated based on design data from any given client and transmits such generated operating simulation data to the given client over the network,
the given client making an operating simulation linked to design data according to the other clients displayable by receiving the operating simulation data transmitted from the server and displaying a screen on which design is carried out.

2. The three-dimensional CAD system according to claim 1, wherein:
the plurality of clients includes a mechanical CAD that carried out mechanical design and an electronic circuit CAD that carries out electronic circuit design; and
the server generates a three-dimensional model of a mechanical unit based on data designed by the mechanical CAD and distributes such generated three-dimensional model to the mechanical CAD.

3. The three-dimensional CAD system according to claim 2, wherein the server generates an operating simulation that reflects operation based on an electronic circuit designed using the electronic circuit CAD for a three-dimensional model of a mechanical unit designed using the mechanical CAD and distributes such generated operating simulation to the mechanical CAD.

4. A server system in a three-dimensional CAD system comprising:
a server; and
a plurality of clients,
the server and the plurality of clients connected by a network,
the server comprising a data storage unit that stores data and a computing unit that reads and writes data to and from the data storage unit in response to requests from the clients and generates a three-dimensional model and an operating simulation of such three-dimensional model,
the server making it possible to display on a given client side an operating simulation linked to design data according to other clients by using the computing unit to generate operating simulation data for a three-dimensional model generated by causing design data according to the other clients to be reflected in a three-dimensional model generated based on design data from the given client, and transmits such generated operating simulation data to the given client over the network.

5. The server system according to claim 4, wherein:
the plurality of clients includes a mechanical CAD that carried out mechanical design and an electronic circuit CAD that carries out electronic. circuit design; and
the server generates a three-dimensional model of a mechanical unit based on data designed by the mechanical CAD and distributes such generated three-dimensional model to the mechanical CAD.

6. The server system according to claim 5, wherein the server generates an operating simulation that reflects operation based on an electronic circuit designed using the electronic circuit CAD for a three-dimensional model designed using the mechanical CAD, and distributes such generated operating simulation to the mechanical CAD.

7. A client CAD system in a three-dimensional CAD system comprising:
a server; and
a plurality of clients,
the server and the plurality of clients connected by a network,
the server comprising a data storage unit that stores data and a computing unit that reads and writes data to and from the data storage unit in response to requests from the clients and generates a three-dimensional model and an operating simulation of such three-dimensional model,
the server, using the computing unit, generating operating simulation data for a three-dimensional model generated by causing design data according to other clients to be reflected in a three-dimensional model generated based on design data from any given client and transmits such generated operating simulation data to the given client over the network,
the given client making an operating simulation linked to design data according to the other clients displayable by receiving and displaying on a screen on which design is carried out the operating simulation data transmitted from the server.

8. The client CAD system according to claim 7, wherein:
the plurality of clients includes a mechanical CAD that carried out mechanical design and an electronic circuit CAD that carries out electronic circuit design;
the server generates a three-dimensional model of a mechanical unit based on data designed by the mechanical CAD and distributes such generated three-dimensional model to the mechanical CAD; and
the mechanical CAD makes the three-dimensional model displayable on a design screen of the designed mechanical unit.

9. The client CAD system according to claim 8, wherein:
the server generates an operating simulation that reflects operation based on an electronic circuit designed using the electronic circuit CAD for a three-dimensional model of a mechanical unit designed using the mechanical CAD and distributes such generated operating simulation to the mechanical CAD: and
the mechanical CAD makes the three-dimensional model and an electronic circuit designed using the electronic circuit CAD displayable on the designed mechanical unit design screen.
